(19) United States
(12) Patent Application Publication
(10) Pub. No.: US 2010/0115407 A1
(43) Pub. Date: May 6, 2010

(54) MOBILE TERMINAL AND DISPLAYING METHOD THEREOF

(75) Inventors: Hyoungmi Kim, Seoul (KR); Hyolin Kim, Seoul (KR); Gu-Ang Jang, Seoul (KR); Jina Chang, Seoul (KR)

Correspondence Address: LEE, HONG, DEGERMAN, KANG & WAIMEY, 660 S. FIGUEROA STREET, Suite 2300, LOS ANGELES, CA, 90017, US

(73) Assignee: LG ELECTRONICS INC.

(21) Appl. No.: 12/406,928

(22) Filed: Mar. 18, 2009

(30) Foreign Application Priority Data
Nov. 5, 2008 (KR) 10-2008-0109408

(51) Int. Cl. G06F 3/048; G06F 3/00

(52) U.S. Cl. 715/708; 715/768; 715/801

(57) ABSTRACT

A method of displaying in a mobile terminal includes displaying a map on a display unit, displaying at least one icon on the map, the at least one icon being linked to a certain area of the displayed map, receiving a signal for changing a scale of the map, changing the scale of the map in response to the signal and displaying the map according to the changed scale, displaying the at least one icon differently according to the changed scale of the map, wherein the at least one icon is updated when map data corresponding to the certain area is changed, the map data comprising first map data corresponding to a first time point and second map data corresponding to a second time point, and displaying a first icon corresponding to the first map data and a second icon corresponding to the second map data differently to indicate a change of the map data between the first time point and the second time point.

### CROSS-REFERENCE TO RELATED APPLICATIONS

Pursuant to 35 U.S.C. § 119(a), this application claims the benefit of earlier filing date and right of priority to Korean Patent Application No. 10-2008-0109408 filed on Nov. 5, 2008, the contents of which are hereby incorporated by reference herein in their entirety.

### FIELD OF THE INVENTION

The present invention relates to a mobile terminal and a method of displaying thereof for displaying icons on a specific area on a map such that the icons correspond to the scale of the map, thus improving visibility of icons and facilitating easy identification of the icons.

### DISCUSSION OF THE RELATED ART

As the functions of terminals such as personal computers, laptop computers, cellular phones and the like are diversified, the terminals are constructed in the form of a multimedia player having multiple functions such as capturing pictures or moving images; playing music; moving image files and games; and receiving broadcasting programs.

Terminals can be divided into mobile terminals and stationary terminals. Further, the mobile terminals can be classified into handheld terminals and vehicle mounted terminals according to portability of the terminals.

A variety of recent terminals including mobile terminals provide more complex and various functions. To support and enhance the complex functions of a terminal, a structural part and/or a software part of the terminal needs to be continuously improved.

### SUMMARY OF THE INVENTION

In accordance with an embodiment, a method of displaying in a mobile terminal includes displaying a map on a display unit, displaying at least one icon on the map, the at least one icon being linked to a certain area of the displayed map, receiving a signal for changing a scale of the map, changing the scale of the map in response to the signal and displaying the map according to the changed scale, displaying the at least one icon differently according to the changed scale of the map, wherein the at least one icon is updated when map data corresponding to the certain area is changed, the map data comprising first map data corresponding to a first time point and second map data corresponding to a second time point, and displaying a first icon corresponding to the first map data and a second icon corresponding to the second map data differently to indicate a change of the map data between the first time point and the second time point.

In accordance with an embodiment, a method of displaying in a mobile terminal includes scaling up or down a map displayed on a display unit in response to an input received through a user input unit, adjusting at least one of a size or shape of contents comprising position information and time information according to the scaled up or scaled down map, displaying the adjusted contents corresponding to the position information at a position on the map, displaying the contents according to a change in map data when the map data is changed and selectively displaying icons corresponding to a set time range based on the time information.

In accordance with an embodiment, a mobile terminal includes a display unit comprising a touch screen, a memory configured to store map data and contents comprising position information and time information, and a controller configured to display a map that corresponds to the stored map data and icons on the display unit, receive a signal for changing a scale of the map, display the map and the icons changed in response to the signal, display the icons differently according to changed map data when the map data is changed, and selectively display icons corresponding to a set time range based on the time information.

These and other embodiments will also become readily apparent to those skilled in the art from the following detailed description of the embodiments having reference to the attached figures, the invention not being limited to any particular embodiment disclosed.

### BRIEF DESCRIPTION OF THE DRAWINGS

The above and other aspects, features, and advantages of the present invention will become more apparent upon consideration of the following description of preferred embodiments, taken in conjunction with the accompanying drawings.

FIG. 1 is a block diagram of a mobile terminal according to an embodiment of the present invention.

FIG. 2A is a front perspective view of the mobile terminal according to an embodiment of the present invention.

FIG. 2B is a rear perspective view of the mobile terminal according to an embodiment of the present invention.

FIGS. 2C and 2D illustrate various forms of the mobile terminal and display screens according to various embodiments of the present invention.

FIG. 3 illustrates a proximity depth of a proximity sensor.

FIG. 4 is a flowchart illustrating displaying in a mobile terminal according to an embodiment of the present invention.

FIG. 5 illustrates various operations of a mobile terminal according to the displaying method illustrated in FIG. 4.

FIG. 6 is a flowchart illustrating displaying a map and icons on the display unit illustrated in FIG. 4.

FIGS. 7A and 7B illustrate an operation of displaying icons when map data is changed in a mobile terminal according to an embodiment of the present invention.

FIG. 8 is a flow chart illustrating displaying icons according to the scale of the map illustrated in FIG. 4.

FIGS. 9A and 9B illustrate an operation of displaying selected icons according to performing a predetermined operation on the displayed icons illustrated in FIG. 4.

FIGS. 10A through 10F illustrate an operation of displaying icons corresponding to a set time range according to performing a predetermined operation on the displayed icons illustrated in FIG. 4;

FIGS. 11A and 11B illustrate an operation of displaying only icons corresponding to a selected category according to performing a predetermined operation on the displayed icons illustrated in FIG. 4.

FIGS. 12A and 12B illustrate an operation of displaying a plurality of contents according to performing a predetermined operation on the displayed icons illustrated in FIG. 4.

### DETAILED DESCRIPTION OF THE PREFERRED EMBODIMENTS

In the following detailed description, reference is made to the accompanying drawing figures which form a part hereof, and which show by way of illustration specific embodiments of the invention. It is to be understood by those of ordinary skill in this technological field that other embodiments may be utilized, and structural, electrical, as well as procedural changes may be made without departing from the scope of the present invention. Wherever possible, the same reference numbers will be used throughout the drawings to refer to the same or similar parts.

Hereinafter, a mobile terminal relating to the present invention will be described below in more detail with reference to the accompanying drawings. In the following description, the terms “module” and “unit” are given to components of the mobile terminal in consideration of only facilitation of description and do not have meanings or functions discriminated from each other. The mobile terminal described in the specification may include a cellular phone, a smart phone, a laptop computer, a digital broadcasting terminal, a personal digital assistant (PDA), a portable multimedia player (PMP), a navigation system and the like.

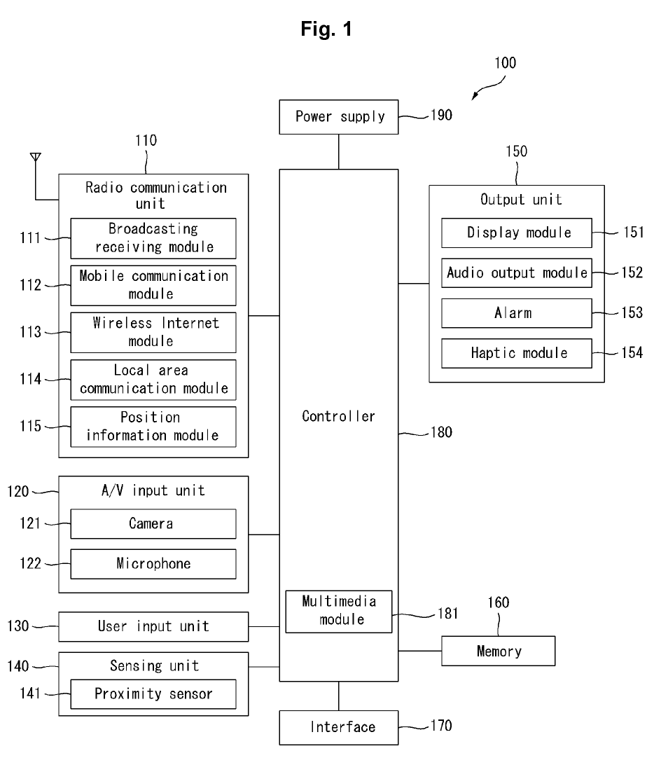

FIG. 1 is a block diagram of a mobile terminal 100 according to an embodiment of the present invention. The mobile terminal 100 includes a radio communication unit 110, an audio/video (A/V) input unit 120, a user input unit 130, a sensing unit 140, an output unit 150, memory 160, an interface 170, a controller 180, and a power supply 190. Some components shown in FIG. 1 may not be essential parts and the number of components included in the mobile terminal 100 may be varied.

The radio communication unit 110 includes at least one module that enables radio communication between the mobile terminal 100 and a radio communication system or between the mobile terminal 100 and a network in which the mobile terminal 100 is located. For example, the radio communication unit 110 may include a broadcasting receiving module 111, a mobile communication module 112, a wireless Internet module 113, a local area communication module 114 and a position information module 115.

The broadcasting receiving module 111 receives broadcasting signals and/or broadcasting related information from an external broadcasting management server through a broadcasting channel. The broadcasting channel may include a satellite channel and a terrestrial channel. The broadcasting management server can be a server that generates and transmits broadcasting signals and/or broadcasting related information or a server that receives previously created broadcasting signals and/or broadcasting related information and transmits the broadcasting signals and/or broadcasting related information to the mobile terminal 100. The broadcasting signals include not only TV broadcasting signals, radio broadcasting signals and data broadcasting signals, but may also include signals in the form of combination of a TV broadcasting signal and a radio broadcasting signal.

The broadcasting related information may be information on a broadcasting channel, a broadcasting program or a broadcasting service provider. The broadcasting related information can be provided even through a mobile communication network. In this case, the broadcasting related information can be received by the mobile communication module 112.

The broadcasting related information can exist in various forms. For example, the broadcasting related information can exist in the form of electronic program guide (EPG) of digital multimedia broadcasting (DMB) or in the form of electronic service guide (ESG) of digital video broadcast-handheld (DVB-H).

The broadcasting receiving module 111 receives broadcasting signals using various broadcasting systems. Particularly, the broadcasting receiving module 111 can receive digital broadcasting signals using digital broadcasting systems such as digital multimedia broadcasting-terrestrial (DMB-T), digital multimedia broadcasting-satellite (DMB-S), media forward link only (MediaFLO), DVB-H and integrated services digital broadcast-terrestrial (ISDB-T) systems. The broadcasting receiving module 111 can be constructed to be suited to broadcasting systems providing broadcasting signals other than the above-described digital broadcasting systems. The broadcasting signals and/or broadcasting related information received through the broadcasting receiving module 111 can be stored in the memory 160.

The mobile communication module 112 transmits/receives a radio signal to/from at least one of a base station, an external terminal or a server on a mobile communication network. The radio signal may include a voice call signal, a video telephony call signal or data in various forms according to transmission and receiving of text/multimedia messages.

The wireless Internet module 113 may include a module for wireless Internet access and can be included in the mobile terminal 100 or externally attached to the mobile terminal 100. Wireless LAN (WLAN) (Wi-Fi), wireless broadband (Wibro), world interoperability for microwave access (Wimax), high speed downlink packet access (HSDPA) and the like can be used for wireless Internet.

The local area communication module 114 is for local area communication. For example, Bluetooth, radio frequency identification (RFID), infrared data association (IrDA), ultra wideband (UWB) and ZigBee can be used as a local area communication technique.

The position information module 115 confirms or obtains the position of the mobile terminal 100. A global positioning system (GPS) module is a representative example of the position information module 115. According to the current technology, the GPS module 115 can calculate information on distances between one point (object) and at least three satellites and information on the time when the distance information is measured and apply trigonometry to the obtained distance information to obtain three-dimensional position information on the point (object) according to latitude, longitude and altitude at a predetermined time. Furthermore, a method of calculating position and time information using three satellites and correcting the calculated position and time information using another satellite is also used. In addition, the GPS module 115 continuously calculates the current position in real time and calculates velocity information using the position information.

Further referring to FIG. 1, the A/V input unit 120 is used to input an audio signal or a video signal and may include a camera 121 and a microphone 122. The camera 121 processes image frames of still images or moving images obtained by an image sensor in a video telephony mode or a photographing mode. The processed image frames can be displayed on a display unit 151.

The image frames processed by the camera 121 can be stored in the memory 160 or transmitted to an external device through the radio communication unit 110. The mobile terminal 100 may include more than one camera 121.

The microphone 122 receives an external audio signal in a call mode, a recording mode or a speed recognition mode and processes the received audio signal into electric audio data. The audio data can be converted into a form that can be transmitted to a mobile communication base station through the mobile communication module 112 and output in the call mode. The microphone 122 can employ various noise removal algorithms for removing noise generated when the external audio signal is received.

The user input unit 130 receives input data for controlling the operation of the mobile terminal 100 from a user. The user input unit 130 includes a keypad, a dome switch, a touch pad (constant voltage/capacitance), jog wheel, jog switch and the like.

The sensing unit 140 senses the current state of the mobile terminal 100, such as open/close state of the mobile terminal 100, the position of the mobile terminal 100, whether a user touches the mobile terminal 100, the direction of the mobile terminal 100 and acceleration/deceleration of the mobile terminal 100 and generates a sensing signal for controlling the operation of the mobile terminal 100. For example, the sensing unit 140 can sense whether a slide phone is opened or closed when the mobile terminal 100 is a slide phone. Furthermore, the sensing unit 140 can sense whether the power supply 190 supplies power and whether the interface 170 is connected to an external device. The sensing unit 140 may include a proximity sensor.

The output unit 150 generates visual, auditory or tactile output and includes the display module 151, an audio output module 152, an alarm 153 and a haptic module 154. The display module 151 displays information processed by the mobile terminal 100. For example, the display module 151 displays a user interface (UI) or graphic user interface (GUI) related to a telephone call when the mobile terminal 100 is in the call mode. The display module 151 displays a captured or/and received image, UI or GUI when the mobile terminal 100 is in the video telephony mode or the photographing mode.

The display module 151 includes at least one of a liquid crystal display, a thin film transistor liquid crystal display, an organic light-emitting diode display, a flexible display or a three-dimensional display. Some of these displays can be of a transparent type or a light transmission type. This can be referred to as a transparent display. The transparent display includes a transparent liquid crystal display. The rear structure of the display module 151 can also be of the light transmission type. According to this structure, a user can see an object located behind the body of the mobile terminal 100 through an area of the body of the mobile terminal 100, which is occupied by the display module 151.

The mobile terminal 100 may include more than one display module 151. For example, the mobile terminal 100 may include a plurality of display modules 151 that are arranged on a single face at a predetermined distance or integrated. Otherwise, the plurality of display modules 151 may be arranged on different sides.

When the display module 151 and a sensor sensing touch (a touch sensor hereinafter) form a layered structure, it is referred to as a touch screen, which enables the display module 151 to be used as an input device in addition to an output device. The touch sensor may be in the form of a touch film, a touch sheet and a touch pad, for example.

The touch sensor can be constructed such that it converts a variation in pressure applied to a specific portion of the display module 151 or a variation in capacitance generated at a specific portion of the display module 151 into an electric input signal. The touch sensor can be constructed such that it can sense pressure of touch as well as the position and area of touch.

When touch input is applied to the touch sensor, a signal corresponding to the touch input is transmitted to a touch controller. The touch controller processes the signal and transmits data corresponding to the processed signal to the controller 180. Accordingly, the controller 180 can detect a touched portion of the display module 151.

The proximity sensor 141 may be located in an internal region of the mobile terminal 100, surrounded by the touch screen, or near the touch screen. The proximity sensor 141 senses an object approaching a predetermined sensing face or an object located near the proximity sensor 141 using electromagnetic force or infrared rays without having mechanical contact. The proximity sensor 141 generally will have a lifetime longer than that of a contact touch sensor and may be used for wider applications.

The proximity sensor 141 includes a transmission type photo-electric sensor, a direct reflection type photo-electric sensor, a mirror reflection type photo-electric sensor, a high-frequency oscillating proximity sensor, a capacitive proximity sensor, a magnetic proximity sensor, an infrared proximity sensor, and the like. A capacitive touch screen is constructed such that proximity of a pointer is detected through a variation in an electric field according to the proximity of the pointer. In this case, the touch screen (touch sensor) can be classified as a proximity sensor 141.

For convenience of explanation, an action of approaching the pointer to the touch screen while the pointer is not being in contact with the touch screen such that location of the pointer on the touch screen is recognized is referred to as “proximity touch” and an action of bring the pointer into contact with the touch screen is referred to as “contact touch” in the following description. A proximity touch point of the pointer on the touch screen means a point of the touch screen to which the pointer corresponds perpendicularly to the touch screen when the pointer proximity-touches the touch screen.

The proximity sensor 141 senses proximity touch and a proximity touch pattern, for example, a proximity touch distance, a proximity touch direction, a proximity touch velocity, a proximity touch time, a proximity touch position, and a proximity touch moving state. Information corresponding to the sensed proximity touch action and proximity touch pattern can be displayed on the touch screen.

The audio output module 152 outputs audio data received from the radio communication unit 110 or stored in the memory 160 in a call signal receiving mode, a telephone call mode or a recording mode, a speech recognition mode and a broadcasting receiving mode. The audio output module 152 outputs audio signals related to functions, such as a call signal incoming tone and a message incoming tone, performed in the mobile terminal 100. The audio output module 152 may include a receiver, a speaker, a buzzer, and the like.

The alarm 153 outputs a signal for indicating generation of an event of the mobile terminal 100. Examples of events generated in the mobile terminal 100 include receiving of a call signal, receiving of a message, input of a key signal, and input of touch. The alarm 153 can output signals in forms different from video signals or audio signals, for example, a signal for indicating generation of an event through vibration. The video signals or the audio signals can be also output through the display module 151 or the audio output module 152.

The haptic module 154 generates various haptic effects that the user can feel. A representative example of the haptic effects is vibration. The intensity and pattern of vibration generated by the haptic module 154 can be controlled. For example, different vibrations can be combined and output or sequentially output.

The haptic module 154 can generate a variety of haptic effects including an effect of stimulus according to arrangement of pins vertically moving for a contact skin face, an effect of stimulus according to jet force or sucking force of air through a jet hole or a sucking hole, an effect of stimulus rubbing the skin, an effect of stimulus according to contact of an electrode, an effect of stimulus using electrostatic force and an effect according to reproduction of cold and warmth using an element capable of absorbing or radiating heat in addition to vibrations.

The haptic module 154 can not only transmit haptic effects through direct contact but also allow the user to feel haptic effects through kinesthetic sense of his fingers or arms. The mobile terminal 100 may include more than one haptic module 154.

The memory 160 may store a program for the operation of the controller 180 and temporarily store input/output data, such as phone book, messages, still images, and moving images. The memory 160 may also store data about vibrations and sounds in various patterns, which are output when a touch input is applied to the touch screen.

The memory 160 includes at least one of a flash memory, a hard disk type memory, a multimedia card micro type memory, a card type memory, such as SD or XD memory, a random access memory (RAM), a static RAM (SRAM), a read-only memory (ROM), an electrically erasable programmable ROM (EEPROM), a programmable ROM (PROM) magnetic memory, a magnetic disk or an optical disk. The mobile terminal 100 can operate in relation to a web storage performing the storing function of the memory 160 on the Internet.

The interface 170 serves as a path to external devices connected to the mobile terminal 100. The interface 170 receives data from external devices or power and transmits the data or power to the internal components of the mobile terminal 100 or transmits data of the mobile terminal 100 to the external devices. For example, the interface 170 includes a wired/wireless headset port, an external charger port, a wired/wireless data port, a memory card port, a port for connecting a device having a user identification module, an audio I/O port, a video I/O port, and an earphone port.

An identification module is a chip that stores information for authenticating the mobile terminal 100 and includes a user identify module (UIM), a subscriber identify module (SIM), a universal subscriber identify module (USIM), or the like. A device including the identification module or identification device can be manufactured in the form of a smart card. Accordingly, the identification device can be connected to the mobile terminal 100 through a port.

The interface 170 can serve as a path through which power from an external cradle is provided to the mobile terminal 100 when the mobile terminal 100 is connected to the external cradle or a path through which various command signals inputted by the user through the cradle to the mobile terminal 100. The various command signals or power input from the cradle can be used as a signal for confirming whether the mobile terminal 100 is correctly set in the cradle.

The controller 180 controls the overall operation of the mobile terminal 100. For example, the controller 180 performs control and processing for voice communication, data communication and video telephony. The controller 180 includes a multimedia module 181 for playing multimedia. The multimedia module 181 can be included in the controller 180 or separated from the controller 180.

The controller 180 can perform a pattern recognition process capable of recognizing handwriting input or picture-drawing input applied to the touch screen as characters or images.

The power supply 190 receives external power and internal power and provides power required for the operations of the components of the mobile terminal 100 under the control of the controller 180.

Various embodiments of the present invention can be implemented in a computer or similar device using readable recording medium using software, hardware or a combination thereof, for example.

According to hardware implementations, the embodiments of the present invention can be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or electrical units for executing functions. In some cases, the embodiments can be implemented by the controller 180.

According to software implementations, embodiments such as procedures or functions can be implemented with a separate software module executing at least one function or operation. Software codes can be implemented according to a software application written in an appropriate software language. Furthermore, the software codes can be stored in the memory 160 and executed by the controller 180.

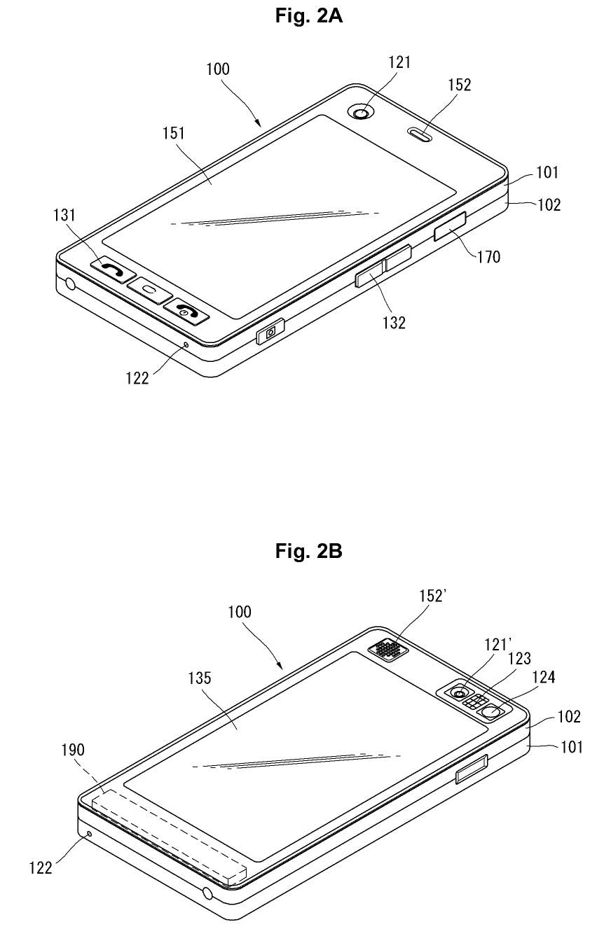

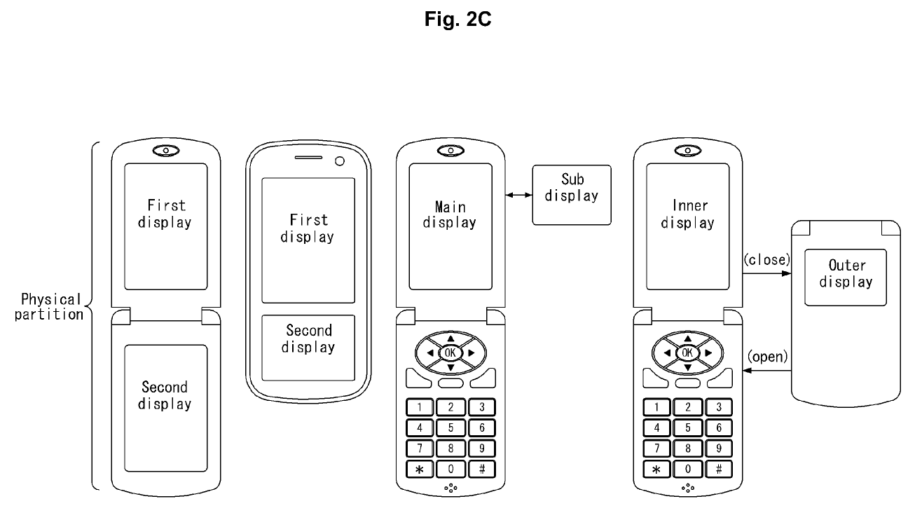

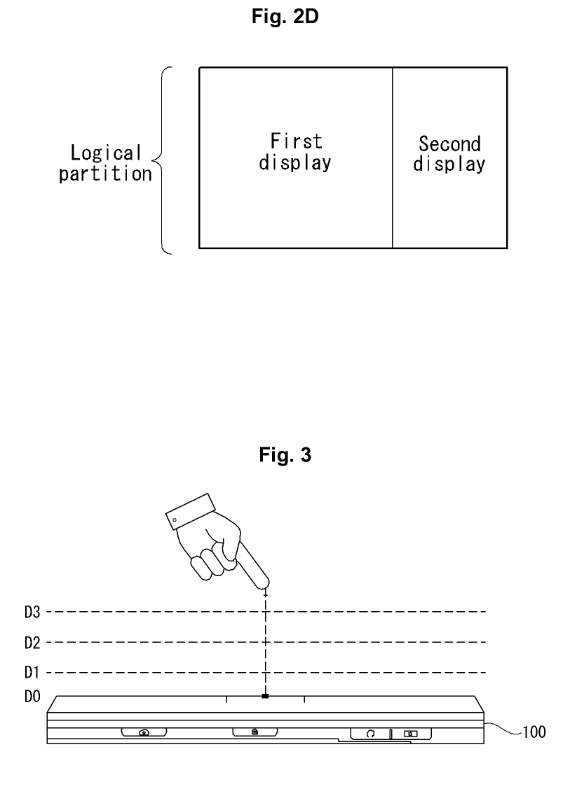

FIG. 2A is a front perspective view of a mobile terminal 100 or a handheld terminal according to an embodiment of the present invention. While the exemplified mobile terminal 100 has a bar type terminal body, the present invention is not limited to a bar type terminal and can be applied to various types or terminals including slide type, folder type, swing type and swivel type terminals having at least two bodies that are relatively movably combined.

The terminal body includes a case, for example, a casing, a housing, and a cover, forming the exterior of the mobile terminal 100. In the present embodiment, the case can be divided into a front case 101 and a rear case 102. Various electronic components are arranged in the space formed between the front case 101 and the rear case 102. At least one middle case can be additionally arranged between the front case 101 and the rear case 102. The cases can be formed of plastics through injection molding or made of a metal material such as stainless steel (STS) or titanium (Ti).

The display module 151, the audio output module 152, the camera 121, the user input unit 130/131 and 132, the microphone 122 and the interface 170 can be arranged in the terminal body, specifically, in the front case 101. The display module 151 occupies portions of the main face of the front case 101. The audio output module 152 and the camera 121 are arranged in a region in proximity to one of both ends of the display module 151 and the user input unit 131 and the microphone 122 are located in a region in proximity to the other end of the display module 151. The user input unit 132 and the interface 170 are arranged on the sides of the front case 101 and the rear case 102.

The user input unit 130 is operated to receive commands for controlling the operation of the mobile terminal 100 and may include a plurality of operating units 131 and 132. The operating units 131 and 132 can be referred to as manipulating portions and employ any tactile manner in which a user operates the operating units 131 and 132 while having tactile feeling.

First and second operating units 131 and 132 can receive various inputs. For example, the first operating unit 131 receives commands such as start, end and scroll and the second operating unit 132 receives commands such as control of the volume of sound output from the audio output module 152 or conversion of the display module 151 to a touch recognition mode.

FIG. 2B is a rear perspective view of the mobile terminal 100 shown in FIG. 2A. Referring to FIG. 2B, a camera 121′ can be additionally attached to the rear side of the terminal body, that is, the rear case 102. The camera 121′ has a photographing direction opposite to that of the camera 121 shown in FIG. 2A and can have pixels different from those of the camera 121 shown in FIG. 2A.

For example, it is desirable that the camera 121 has low pixels such that it can capture an image of the face of a user and transmit the image to a receiving part in case of video telephony while the camera 121′ has high pixels because it captures an image of a general object and does not immediately transmit the image in many cases. The cameras 121 and 121′ can be attached to the terminal body such that they can be rotated or pop-up.

A flash bulb 123 and a mirror 124 are additionally arranged in proximity to the camera 121′. The flash bulb 123 lights an object when the camera 121′ takes a picture of the object. The mirror 124 is used for the user to look at his or her face in the mirror when the user wants to self-photograph himself or herself using the camera 121′.

An audio output module 152′ can be additionally provided on the rear side of the terminal body. The audio output module 152′ can achieve a stereo function with the audio output module 152 shown in FIG. 2A and be used for a speaker phone mode when the mobile terminal 100 is used for a telephone call.

A broadcasting signal receiving antenna 124 can be additionally attached to the side of the terminal body in addition to an antenna for telephone calls. The antenna 124 constructing a part of the broadcasting receiving module 111 shown in FIG. 1 can be set in the terminal body such that the antenna 124 can be pulled out of the terminal body.

The power supply 190 for providing power to the mobile terminal 100 is set in the terminal body. The power supply 190 can be included in the terminal body or detachably attached to the terminal body.

A touch pad 135 for sensing touch can be additionally attached to the rear case 102. The touch pad 135 can be of a light transmission type as the display module 151. In this case, if the display module 151 outputs visual information through both sides thereof, the visual information can be recognized through the touch pad 135. The information output through both sides of the display module 151 can be controlled by the touch pad 135. Otherwise, a display is additionally attached to the touch pad 135 such that a touch screen can be arranged even in the rear case 102.

The touch pad 135 operates in connection with the display module 151 of the front case 101. The touch pad 135 can be located in parallel with the display module 151 behind the display module 151. The touch panel 135 can be identical to or smaller than the display module 151 in size.

FIGS. 2C and 2D illustrate the mobile terminal 100 and the display module 151 according to various embodiments of the present invention. Referring to FIG. 2C, the display module 151 includes a first display and a second display which are physically separated from each other. In a folder type or slide type mobile terminal having two bodies connected through a hinge or slide, the first display or main display can be formed on the inner face or outer face of one of the bodies and the second display or sub display can be formed on the inner face or outer face of the other body. The sub display is separated from the mobile terminal 100 and detachably combined with the mobile terminal body through an interface to display data from the mobile terminal 100. Alternatively, the display module 151 can include first and second displays which are logically separated from each other in a display panel, as illustrated in FIG. 2D.

FIG. 3 illustrates a proximity depth of the proximity sensor. As shown in FIG. 3, when a pointer such as a user's finger approaches the touch screen, the proximity sensor 141 located inside or near the touch screen senses the approach and outputs a proximity signal. The proximity sensor can be constructed such that it outputs a proximity signal according to the distance between the pointer approaching the touch screen and the touch screen (referred to as “proximity depth”).

The distance in which the proximity signal is output when the pointer approaches the touch screen is referred to as a detection distance. The proximity depth can be known by using a plurality of proximity sensors 141 having different detection distances and comparing proximity signals respectively output from the plurality of proximity sensors 141.

FIG. 3 shows the section of the touch screen in which proximity sensors capable of sensing three proximity depths are arranged. Proximity sensors capable of sensing less than three or more than four proximity depths can also be arranged in the touch screen.

Specifically, when the pointer completely comes into contact with the touch screen (D0), it is recognized as a contact touch. When the pointer is located within a distance D1 from the touch screen, it is recognized as proximity touch of a first proximity depth. When the pointer is located in a range between the distance D1 and a distance D2 from the touch screen, it is recognized as proximity touch of a second proximity depth. When the pointer is located in a range between the distance D2 and a distance D3 from the touch screen, it is recognized as a proximity touch of a third proximity depth. When the pointer is located at a range longer than the distance D3 from the touch screen, it is recognized as cancellation of proximity touch. Accordingly, the controller 180 can recognize the proximity touch as various input signals according to the proximity distance and proximity position of the pointer with respect to the touch screen and perform various operation controls according to the input signals.

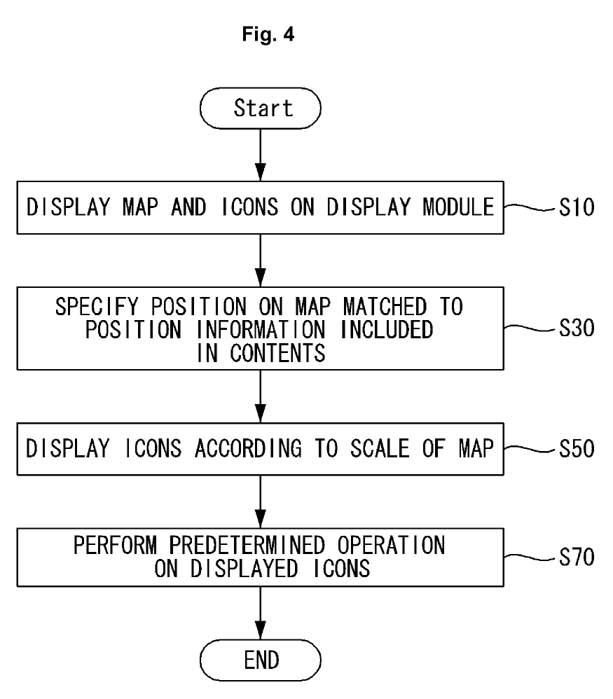

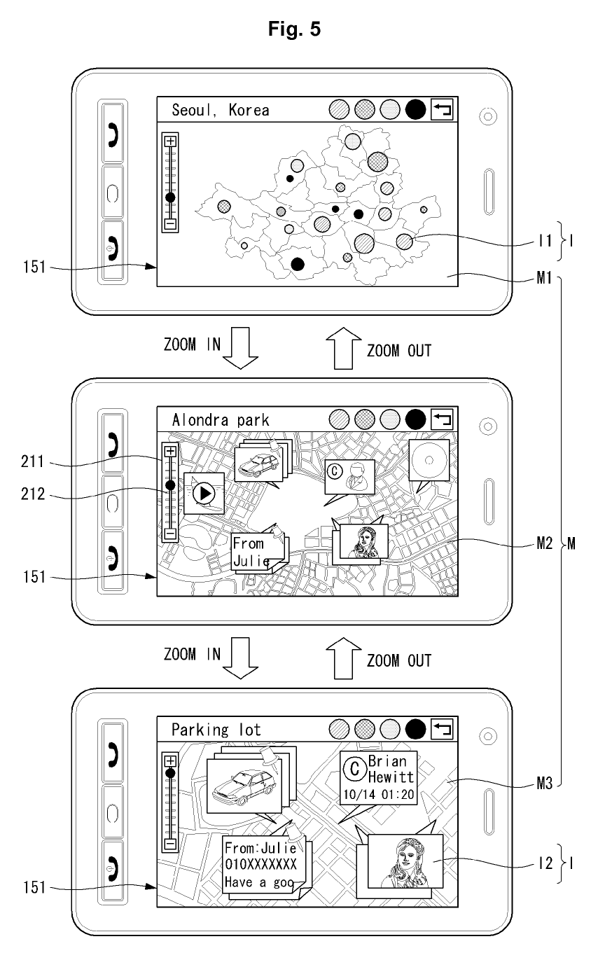

FIG. 4 illustrates a displaying method in a mobile terminal according to an embodiment of the present invention and FIG. 5 illustrates operations of the mobile terminal according to the displaying method illustrated in FIG. 4. Referring to FIGS. 4 and 5, the displaying method includes an operation S10 of displaying a map M and icons I on the display module 151.

The map M includes a map of a specific area, a map of a specific nation and a map of the whole world, which are drawn in various scales. The map M can display a specific area in different scales as represented by a first map M1, a second map M2 and a third map M3. That is, the first, second and third maps M1, M2 and M3 zoom in or zoom out the specific area and display the specific area in different scales.

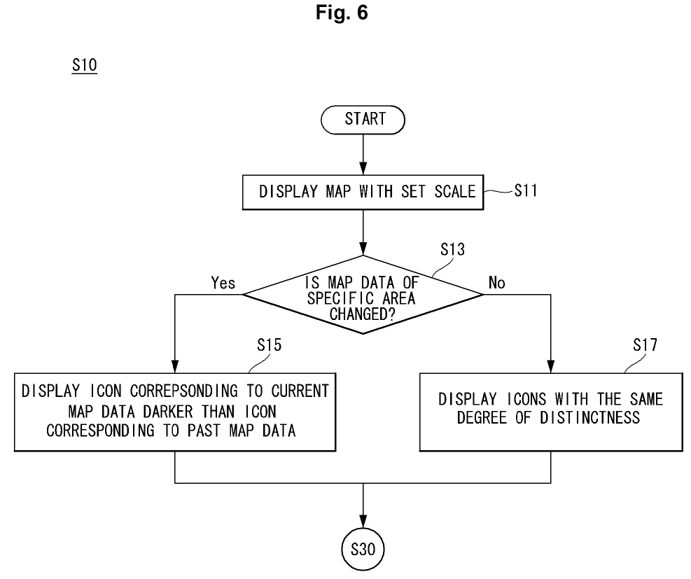

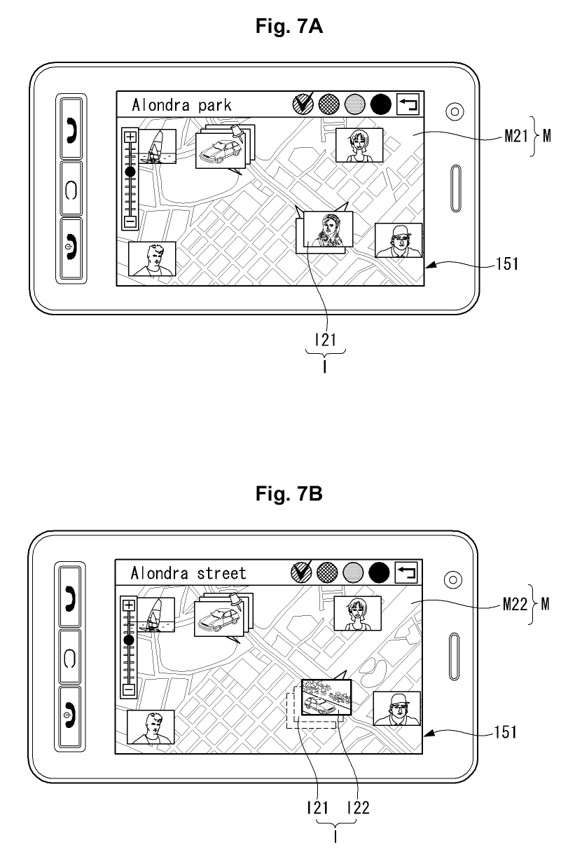

The map M can be stored in the memory 160 illustrated in FIG. 1 or downloaded through the radio communication unit 110 illustrated in FIG. 1 if required. Although FIG. 5 illustrates that the map M is displayed as the first, second and third maps M1, M2 and M3 in three different scales, the scale of the map M is not limited thereto. The map M is initially displayed on a specific scale, and then the scale of the map M is adjusted by vertically moving an adjustment bar 212 of a scale controller 211. The operation of displaying the map M and the icons I will be explained in more detail below with reference to FIGS. 6, 7A and 7B.

When the map M is displayed, a position on the map M, which is matched to position information included in contents is specified in operation S30. The contents are classified into categories such as multimedia and communication and include pictures, video contents, audio contents, details of phone calls, messages and memos. The contents may also include position information.

The position information represents a position where contents are produced. For example, the position information represents a place where a picture is photographed when the contents correspond to the picture and the position information represents a place where a call is received when the contents correspond to details of the call. The position information can be acquired through the position information module 115 illustrated in FIG. 1 and automatically combined with the contents or input by a user and combined with the contents. The position information can correspond to longitude, latitude or the name of an area.

When the scale of the map M is changed by a user, the position on the map M on the changed scale where the contents are displayed is also varied. Accordingly, the position on the map M is specified based on the position information in consideration of the scale of the map M.

When the position on the map M is specified, the icons I are displayed on the map M such that the icons I correspond to the scale of the map M in operation S50. The icons I are respectively correspond to contents. The icons I can be displayed as symbols I1 or thumbnails 12 according to the scale of the map M.

The icons I is displayed as symbols 11 when a relatively wide area is displayed in the case of a small scale map. That is, when a wide area is displayed, contents can be represented by circular dots in different colors and patterns according to categories thereof because a large quantity of information can be displayed in the wide area. Accordingly, the user can recognize what kind of contents is created in which area by just seeing the symbols I1 in different colors. The symbols I1 can be displayed on the map M on scales smaller than a predetermined scale and the symbols I1 and the thumbnails I2 can be simultaneously displayed if required.

The icons I are displayed as thumbnails I2 when a relatively small area is displayed in the case of a large scale map. The thumbnails I2 correspond to contents such as pictures displayed as small images. The user can easily determine whether to select a specific icon through the displayed thumbnails I2.

When the icons I are displayed, a predetermined operation is performed on the displayed icons I to generate a specific event in operation S70. Specifically, the user selects an icon I, selects a specific time and displays only icons I corresponding to the specific time, selects a specific category and displays only icons I corresponding to the specific category, or controls superposed thumbnails I2 to be spread and displayed. Detailed examples of the operation performed on the displayed icons I will be explained below.

FIG. 6 illustrates the operation of displaying the map on the display module 151 illustrated in FIG. 4. The operation of displaying the map on the display module 151 will now be explained with reference to FIGS. 6, 7A and 7B.

The map M is displayed in a specific scale on the display module 151 in S11. When the map M is initially displayed on the display module 151, the map M can be displayed in a predetermined specific scale.

When the map M is displayed, it is determined whether map data corresponding to a specific area on the map M is changed in S13. The map data includes an object such as a building or a road in the specific area or the name of the specific area indicated on the map M. The building, road and name can vary with time. For example, a place where a building was located can be changed to a park and a place where a restaurant was located can be changed to an office building. When the building, road and name are changed, map data corresponding thereto is also changed. When the map data is changed, icons I corresponding to the current map data can be displayed darker than icons I corresponding to the previous map data in S15.

FIG. 7A illustrates the past map M21 of the specific area and FIG. 7B illustrates the current map M22 of the specific area. As illustrated in FIGS. 7A and 7B, a place where buildings were located has been changed to a road. However, a past thumbnail representing the past buildings may remain as illustrated in FIG. 7A. Furthermore, a current thumbnail I22 corresponding to a picture of the current road is indicated, as illustrated in FIG. 7B.

In this case, the past thumbnail I21 can be displayed relatively indistinctly and the current thumbnail I22 can be displayed relatively clearly, as illustrated in FIG. 7B. That is, the transparency of the past thumbnail I21 is adjusted such that the past thumbnail becomes semi-transparent. Accordingly, the user can easily distinguish the current thumbnail I22 from the past thumbnail I21 even though the current thumbnail I22 and the past thumbnail 121 are displayed in a superposed manner.

The current thumbnail I22 is displayed together with the past thumbnail I21 such that the user can be intuitively aware of that there has been a variation in the corresponding area and contents have been generated from the area. Furthermore, the user can recognize that the mobile terminal 100 functions not only as a communication device but also as a device for recording and storing a footprint or path of a person. The user can select the current thumbnail I22 or the past thumbnail I21 to confirm contents corresponding to the selected thumbnail.

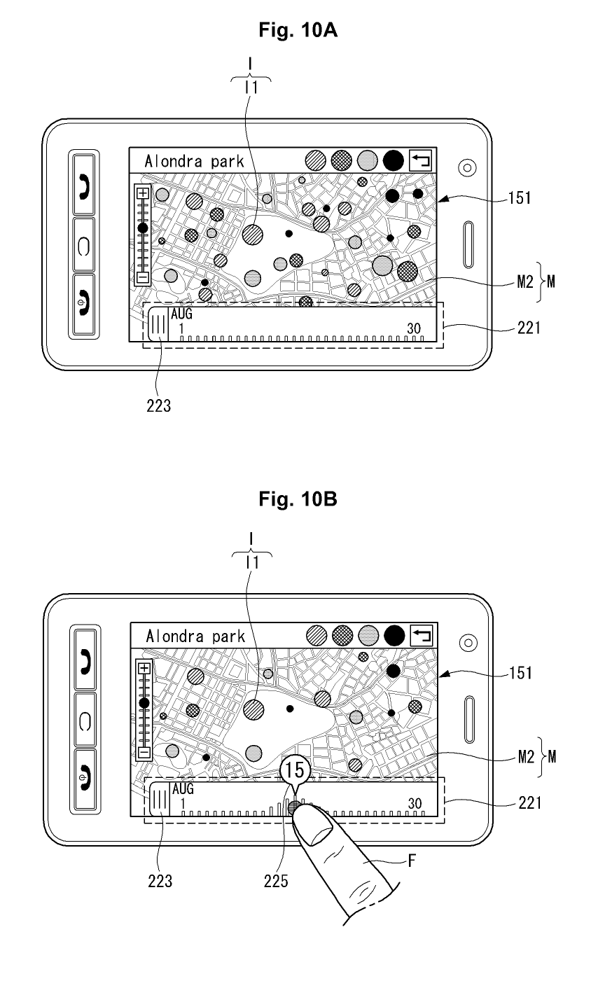

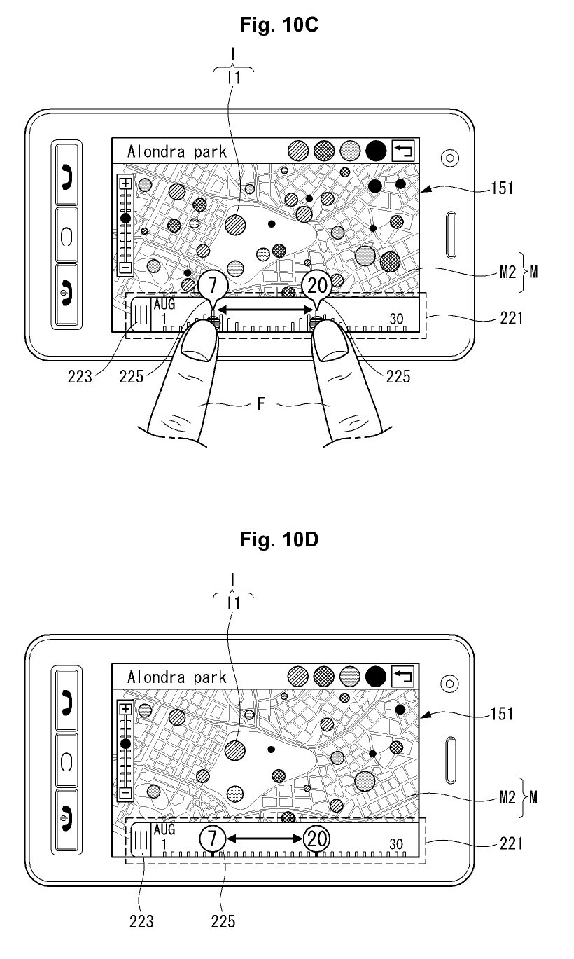

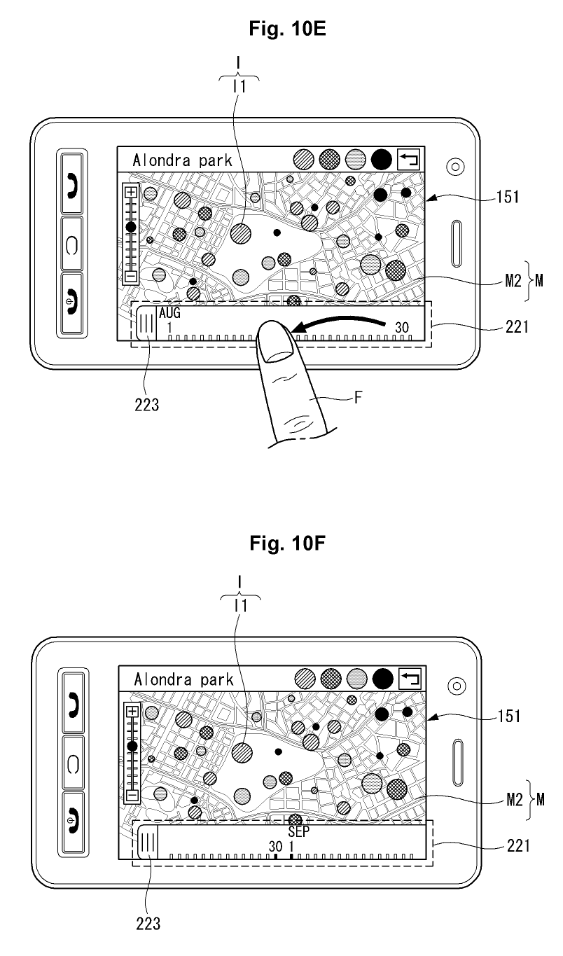

Although FIG. 7B illustrates that the current thumbnail I22 and the past thumbnail I21 are displayed in different degrees of distinctness, it is also possible to omit the past thumbnail I21. Furthermore, when a specific point of time or a specific period of time of the past is selected through a time range controller 221 illustrated in FIG. 10A, a map M and icons I corresponding to the point of time or the time can be displayed. When the map data is not changed, the thumbnails I21 and I22 can be displayed with the same degree of distinctness in operation S17.

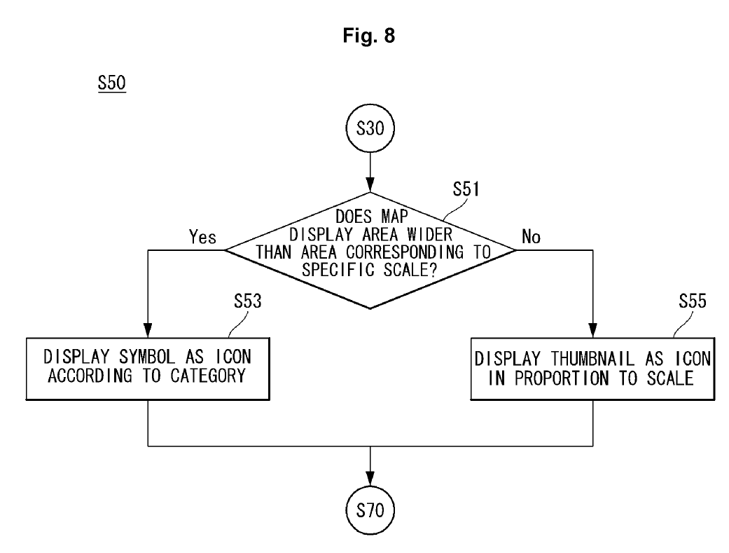

FIG. 8 illustrates the operation of indicating the icons such that the icons correspond to the scale of the map, illustrated in FIG. 4. The operation of indicating the icons will now be explained with reference to FIGS. 5 and 8.

It is determined whether the map M is set such that the map M displays an area wider than an area corresponding to a specific scale in S51. The specific scale can be preset. For example, the specific scale can be set to 1:25,000 or 1:50,000. That is, it is determined whether the user wants to display an area wider than the area corresponding to the specific scale.

When the map M is set such that the map M displays an area wider than the area corresponding to the specific scale according to the user's choice, symbols I1 are displayed as icons I according to category in S53. That is, the symbols I1 are displayed on the first map M1 that displays a wide area to provide a large quantity of information.

When the map M is set such that the map M displays an area smaller than the area corresponding to the specific scale according to the user's choice, thumbnails I2 are displayed as icons I in proportion to the scale in S55. That is, the size of the thumbnails I2 can be varied with the scale.

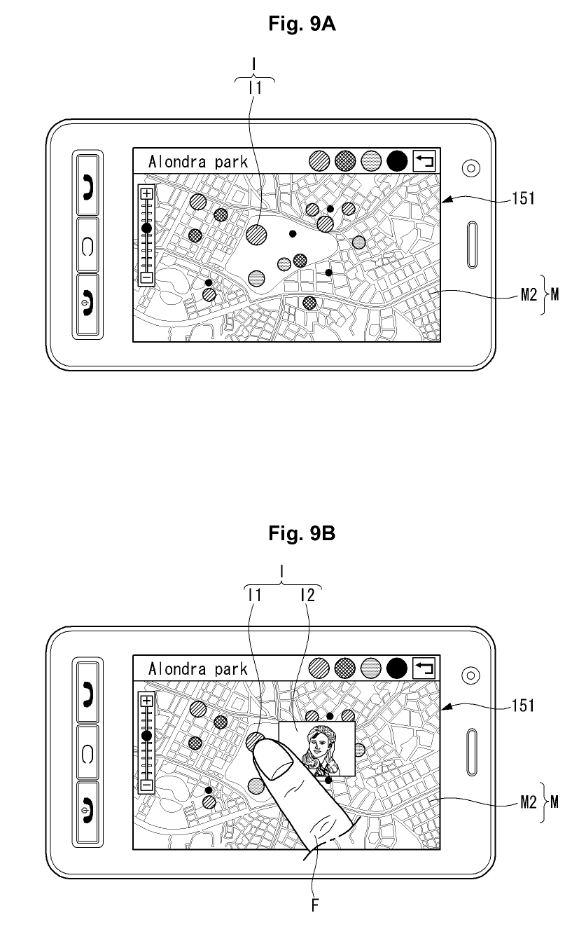

FIGS. 9A and 9B illustrate an operation of displaying selected icons according to performing a predetermined operation on the display icons illustrated in FIG. 4. Referring to FIGS. 9A and 9B, the display module 151 displays the second map M2. Symbols I1 can be displayed as Icons I according to categories of contents in the case of the scale of the second map M2, as described above.

The user can select symbol I1 corresponding to contents that the user wants to know in detail from the displayed symbol I1 by directly touching the display module 151 with the user's finger F or approaching the finger F to, but not contacting, the display module 151.

When one of the symbols I1 is selected, a thumbnail I2 corresponding to the selected symbol I1 can be displayed. The thumbnail I2 may include various contents. For example, if the selected symbol I corresponds to a picture, a picture scaled down from the picture can be displayed as the thumbnail I2. If the selected symbol I corresponds to video contents, a reduced picture representing a specific captured scene may be displayed. If the selected symbol I corresponds to a message, an image representing personal information on a person who sent the message and the time when the message is sent and received can be displayed. If the selected symbol I1 corresponds to details of a phone call, an image representing personal information on a caller and the time when the call is received may be displayed.

When thumbnails I2 have been already displayed as the icons I, the user can select a specific thumbnail I2 to display the selected thumbnail I2 on an unselected thumbnails I2 or display contents corresponding to the selected thumbnail I2 on the display module 151. That is, the selected thumbnail I2 is more recognizable than the unselected thumbnail I2.

FIGS. 10A through 10F illustrate an operation of displaying icons corresponding to a set time range according to performing a predetermined operation on the displayed icons illustrated in FIG. 4. FIG. 10A illustrates symbols I1 displayed as icons I and a time range controller 221. A time range for displaying the symbols I1 on the map M can be set through the time range controller 221. That is, when a specific date, a specific month, a specific year or a specific time is selected through the time range controller 221, only symbols I1 corresponding to the selected time range are displayed. The time range controller 221 is displayed or the displayed time range controller 221 disappears by touching a selection button 223.

FIG. 10B illustrates an operation of selecting a specific date. Referring to FIG. 10B, the user can select a specific date, for example, August 15, from dates indicated on the time range controller 221 through direct touch or proximity touch. The time range controller 221 can indicate the date selected by the user in the form of a word balloon 225 such that the user can easily select the date. More specifically, when the user approaches the finger F onto the time range controller 221, a date closest to the finger F is indicated in the word balloon 225 according to proximity touch. The user sees the word balloon 225 while moving the finger F to find a desired date. When the user finds the desired date, the user touches the found date to select the date.

When the specific date is selected, the controller 180 illustrated in FIG. 1 can display only a symbol I1 corresponding to the date from the symbols I1 displayed on the second map M2. Specifically, a symbol I1 corresponds to specific contents that include time information. The time information corresponds to the time when the contents are created or the contents are corrected. For example, a time when a picture is photographed can be inserted into a header file when the contents correspond to the picture. When the contents correspond to a message or details of a phone call, the time information may correspond to the time when the message was received or the time when the call was received and the duration of the call. Accordingly, when the user selects a time range, a symbol I1 corresponding to contents created and corrected in the time range can be displayed. Only an icon I related to a specific date can be selectively displayed, and thus, the user can effectively search for desired contents.

FIGS. 10C and 10D illustrate the operation of selecting a time range. Referring to FIG. 10C, the user may double-touch desired two dates, for example, August 7 and 20, through the time range controller 221 to selectively display symbols I1 belonging to the period between the two dates. Subsequently, the symbols I1 belonging to the period between the two dates are displayed on the map M, as shown in FIG. 10D.

FIGS. 10E and 10F illustrate an operation of changing a date indicated on the time range controller 221. Referring to FIG. 10E, the user may flick the time range controller 221 to the left or right. The speed of changing a date on the time range controller 221 may be varied with flicking speed and strength. That is, dates of the time range controller 221 are rapidly scrolled when the user flicks the time range controller 221 strongly and slowly scrolled when the user flicks the time range controller 221 weakly.

FIG. 10F illustrates that a date of August illustrated in FIG. 10E is changed to a date of September in the time range controller 221 according to flicking.

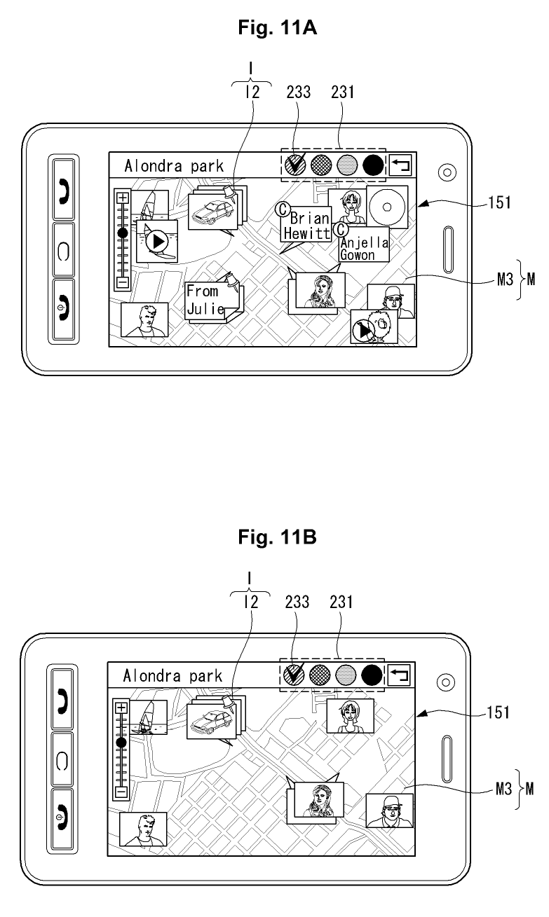

FIGS. 11A and 11B illustrate an operation of displaying only an icon corresponding to a selected category according to performing a predetermined operation on the displayed icons illustrated in FIG. 4. Referring to FIG. 11A, a plurality of icons I corresponding to thumbnails 12 are displayed on the map M. Furthermore, a category selector 231 is displayed at one side of the display module 151. The category selector 231 may include category buttons 233 corresponding to respective categories. For example, the category buttons 233 includes a multimedia button, a communication button and the like. The multimedia button is used to select a picture, video contents, audio contents and the like, and the communication button is used to select details of a phone call, a message and the like.

FIG. 11B illustrates that the user selects the multimedia button from the category buttons 233. Only pictures corresponding to icons I related to multimedia are displayed in FIG. 11B while multiple pictures corresponding to multiple icons I are displayed in FIG. 11A. Accordingly, the user can easily locate a desired picture.

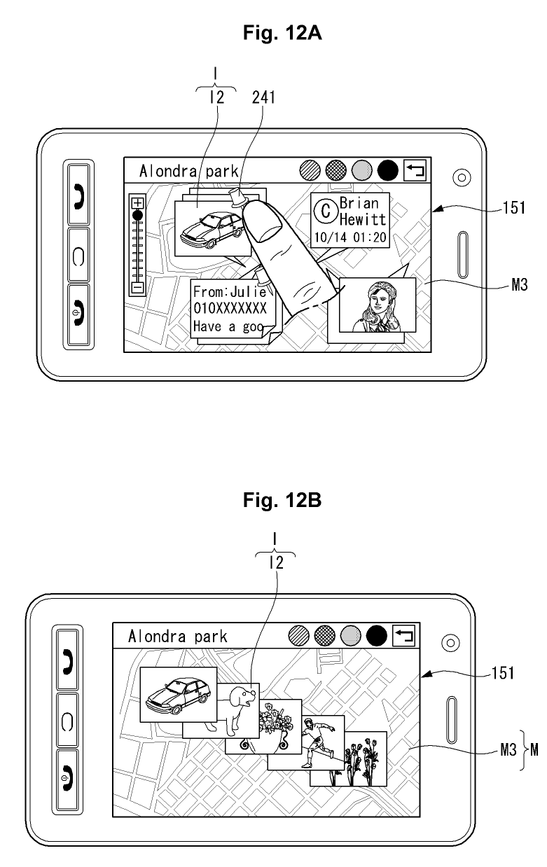

FIGS. 12A and 12B illustrate an operation of displaying a plurality of contents according to performing a predetermined operation on the displayed icons illustrated in FIG. 4. Referring to FIG. 12A, a plurality of thumbnails 12 displayed as icons I may exist in the same area. This frequently occurs when contents corresponding to thumbnails 12 are pictures.

When a plurality of icons I are displayed in a superposed manner, a multi-indication symbol 241 may be displayed. The multi-indication symbol 241 informs the user that a plurality of icons exist at the same position. The user can touch the multi-indication symbol 241 to spread the superposed icons I. FIG. 12B illustrates that superposed icons I are spread in response to the touch of the multi-indication symbol 241.

As described above, when the multi-indication symbol 241 is selected, corresponding icons I are spread and superposed thumbnails I2 are displayed. The user can select a desired thumbnail I2 from the spread thumbnails I2 and confirm detailed information from the selected thumbnail I2. Contents generated at the same position can be displayed in a superposed manner to prevent many contents from being displayed excessively densely and the superposed contents can be spread if required to allow the user to easily use the contents.

While an icon corresponds to one of a symbol and a thumbnail in the aforementioned embodiments for convenience of explanation, a thumbnail can be used instead of a symbol in embodiments in which the symbol is used as an icon and vice versa. It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of displaying in a mobile terminal, the method comprising:
displaying a map on a display unit;
displaying at least one icon on the map, the at least one icon being linked to a certain area of the displayed map;
receiving a signal for changing a scale of the map;
changing the scale of the map in response to the signal and displaying the map according to the changed scale;
displaying the at least one icon differently according to the changed scale of the map, wherein the at least one icon is updated when map data corresponding to the certain area is changed, the map data comprising first map data corresponding to a first time point and second map data corresponding to a second time point; and
displaying a first icon corresponding to the first map data and a second icon corresponding to the second map data differently to indicate a change of the map data between the first time point and the second time point.

2. The method of claim 1, wherein transparency of the first icon and transparency of the second icon are different from each other.

3. The method of claim 1, wherein displaying the at least one icon differently comprises:
displaying in a different size or in a different shape.

4. The method of claim 1, wherein displaying the at least one icon differently comprises:
displaying more information in the at least one icon when the map is scaled up and displaying less information in the at least one icon when the map is scaled down.

5. The method of claim 1, wherein the at least one icon is further linked to contents related to the certain area, the contents being linked to at least one of position information or time information.

6. The method of claim 5, further comprising:
selectively displaying icons corresponding to a set time range based on the time information.

7. The method of claim 5, wherein the position information comprises a position where the contents were produced or generated and the time information comprises a time point when the contents were produced or generated.

8. The method of claim 1, wherein different types of icons are displayed according to categories of contents linked to the icons.

9. The method of claim 8, further comprising:
displaying only icons corresponding to a selected category when one of the categories is selected for displaying.

10. The method of claim 8, wherein the categories of the contents comprise multimedia and communication contents, the multimedia contents comprising: video contents, audio contents, and pictures; and the communication contents comprising: details of phone calls, messages, and memos.

11. The method of claim 1, wherein the at least one icon comprises at least one of a symbol representing contents related to the certain area or a thumbnail representing the contents, the symbol being displayed when the map is displayed at a preset scale or at a scale that is smaller than the preset scale and the thumbnail being displayed when the map is displayed at a scale that is larger than the preset scale.

12. The method of claim 1, further comprising:
outputting contents corresponding to a selected icon when an icon is selected from the at least one displayed icon.

13. The method of claim 12, wherein the contents corresponding to the selected icon are displayed in a preset size irrespective of the scale of the map.

14. The method of claim 1, wherein the map data comprises an object indicated on the specific area and a name of the certain area.

15. A method of displaying in a mobile terminal, the method comprising:
scaling up or down a map displayed on a display unit in response to an input received through a user input unit;
adjusting at least one of a size or shape of contents comprising position information and time information according to the scaled up or scaled down map;
displaying the adjusted contents corresponding to the position information at a position on the map;
displaying the contents according to a change in map data when the map data is changed; and
selectively displaying icons corresponding to a set time range based on the time information.

16. The method of claim 15, further comprising:
displaying the icons differently according to categories of the contents and displaying only icons corresponding to at least one selected category when at least one category is selected from the categories.

17. A mobile terminal comprising:
a display unit comprising a touch screen;
a memory configured to store map data and contents comprising position information and time information; and
a controller configured to:
display a map that corresponds to the stored map data and icons on the display unit;
receive a signal for changing a scale of the map;
display the map and the icons changed in response to the signal;
display the icons differently according to changed map data when the map data is changed; and
selectively display icons corresponding to a set time range based on the time information.

18. The mobile terminal of claim 17, wherein the controller is further configured to change at least one of a size or shape of each icon according to the scale of the map.

19. The mobile terminal of claim 17, wherein the display unit is configured to display a region for setting the time range at a portion of the display unit.

20. The mobile terminal of claim 17, wherein the controller is further configured to display the icons differently according to categories of the contents corresponding to the icons.
